(19) United States
(12) Patent Application Publication
(10) Pub. No.: US 2018/0152586 A1
(43) Pub. Date: May 31, 2018

(54) IMAGE FORMING APPARATUS

(71) Applicant: CANON KABUSHIKI KAISHA, Tokyo (JP)

(72) Inventor: Yasuhiko Hirano, Moriya-shi (JP)

(21) Appl. No.: 15/814,001

(22) Filed: Nov. 15, 2017

(30) Foreign Application Priority Data
Nov. 29, 2016 (JP) 2016-231084

(51) Int. Cl. H04N 1/113; G02B 26/12; G02B 27/00

(52) U.S. Cl. CPC H04N 1/1135; G02B 26/121; H04N 1/121; G02B 27/0031; G02B 26/129

(57) ABSTRACT

An image forming apparatus, including: an image signal generating portion configured to generate an image signal as bit data obtained by splitting image data by a predetermined integer value for each pixel; a first storage portion configured to store a profile indicating magnification correction data for each of a plurality of regions in a main scanning direction; and a second storage portion configured to store a partial magnification granularity being a size of a processing unit used for splitting a partial magnification correction start value, wherein the image signal generating portion calculates a split region boundary address indicating a main scanning position at which a scanning region on the surface of a photosensitive member to be scanned by a light beam is split in the main scanning direction for each partial magnification granularity based on the partial magnification correction start value extracted from the profile and the partial magnification granularity.

### BACKGROUND OF THE INVENTION

### Field of the Invention

The present invention relates to an image forming apparatus including a rotary polygon mirror configured to deflect a light beam so that the light beam emitted from a light source scans a surface of a photosensitive member to form an electrostatic latent image.

### Description of the Related Art

Hitherto, a digital copying machine, a laser beam printer, a facsimile apparatus, or other such electrophotographic image forming apparatus includes a light scanning apparatus configured to scan a surface of a photosensitive member with a light beam to form an electrostatic latent image. In the light scanning apparatus, the light beam is emitted from a light source based on image data. The light beam emitted from the light source is deflected by a rotary polygon mirror. The deflected light beam is transmitted through an imaging lens to be imaged on the surface of the photosensitive member as a light spot. The light spot imaged on the surface of the photosensitive member is moved on the surface of the photosensitive member in accordance with rotation of the rotary polygon mirror to form an electrostatic latent image on the surface of the photosensitive member. A related-art imaging lens has an fθ characteristic. The fθ characteristic represents an optical characteristic of imaging the light beam on the surface of the photosensitive member so that the light spot moves on the surface of the photosensitive member at a constant speed while the rotary polygon mirror is being rotated at a constant angular velocity. Appropriate exposure can be performed through use of an imaging lens having the fθ characteristic. However, the imaging lens having the fθ characteristic is relatively large in size and high in cost. Therefore, for the purpose of reduction in size or cost of an image forming apparatus, it is conceivable to avoid using the imaging lens having the fθ characteristic or to use a small-size low-cost imaging lens that does not have the fθ characteristic. In Japanese Patent Application Laid-Open No. 2005-96351, there is disclosed an image forming apparatus, which uses an imaging lens that does not have the fθ characteristic, and is configured to control a light emission pattern of the light source, to thereby correct a scanning position of the light spot on the surface of the photosensitive member.

However, in the image forming apparatus described in Japanese Patent Application Laid-Open No. 2005-96351, bit data is inserted or extracted (hereinafter also referred to as “inserted/extracted”) into/from each of pixels arranged in a main scanning direction in order to correct the scanning position of the light spot in the main scanning direction, which leads to a problem in that the cost increases due to an increase in scale of a circuit. The number of pixels in the main scanning direction is about 8,000 dots with 1-bit monochrome 600 dpi in an A3 size. In an exemplary case where one pixel is split into 32, 32 pieces of bit data are required for one pixel. Therefore, about 256,000 (=8,000×32) pieces of bit data are required, and the circuit further increases in scale depending on setting of the number of pieces of bit data to be inserted/extracted and a position of the bit data into/from which the bit data is to be inserted/extracted.

### SUMMARY OF THE INVENTION

Therefore, the present invention provides an image forming apparatus configured to suppress a circuit scale by calculating a split region boundary address based on a profile indicating magnification correction data, a partial magnification correction start value, and a partial magnification granularity.

According to one embodiment of the present invention, there is provided an image forming apparatus, which is configured to form an image on a recording medium, comprising:

an image signal generating portion configured to generate an image signal as bit data obtained by splitting image data by a predetermined integer value for each pixel;

a light source configured to emit a light beam based on the image signal;

a deflection device configured to deflect the light beam emitted from the light source so that the light beam scans a surface of a photosensitive member in a main scanning direction;

a lens configured to image the light beam deflected by the deflection device on the surface of the photosensitive member;

a first storage portion configured to store a profile indicating magnification correction data for each of a plurality of regions in the main scanning direction; and

a second storage portion configured to store a partial magnification granularity being a size of a processing unit used for splitting a partial magnification correction start value,

wherein the image signal generating portion is configured to extract the partial magnification correction start value from the profile, and to calculate a split region boundary address indicating a main scanning position at which a scanning region on the surface of the photosensitive member to be scanned by the light beam is split in the main scanning direction for each partial magnification granularity based on the partial magnification correction start value and the partial magnification granularity.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus.

FIG. 2A and FIG. 2B are sectional views of a light scanning apparatus.

FIG. 3 is a graph for showing a partial magnification with respect to an image height for the light scanning apparatus.

FIG. 4 is a block diagram of an exposure control system of the image forming apparatus.

FIG. 5A and FIG. 5B are timing charts of a BD signal and a VDO signal.

FIG. 6 is a block diagram of an image signal generating portion.

FIG. 7 is a block diagram of an image output portion.

FIG. 8 is a flowchart for illustrating a calculation operation for a split region boundary address.

FIG. 9 is an explanatory graph for showing the split region boundary address.

FIG. 10 is a table for showing the calculated split region boundary addresses.

FIG. 11 is a flowchart for illustrating an operation for bit data insertion-extraction corresponding to a split scanning region.

FIG. 12A and FIG. 12B are an explanatory table and an explanatory diagram of the operation for the bit data insertion-extraction.

FIG. 13 is a flowchart for illustrating a calculation operation for the split region boundary address in a second embodiment.

### DESCRIPTION OF THE EMBODIMENTS

Now, exemplary embodiments for carrying out the present invention will be described with reference to the drawings.

### First Embodiment

### <Image Forming Apparatus>

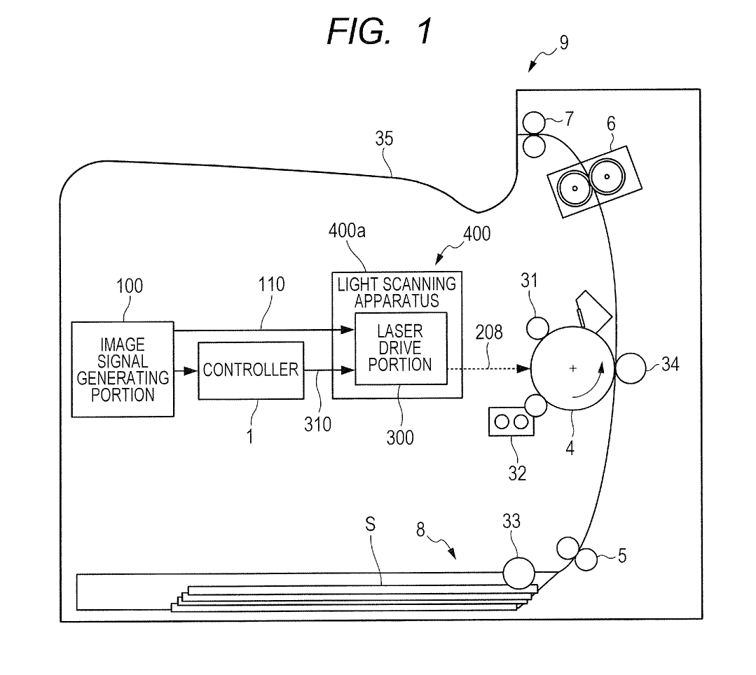

FIG. 1 is a schematic diagram of an image forming apparatus 9. The image forming apparatus 9 includes a light scanning apparatus 400 as a light scanning unit configured to scan a surface of a photosensitive drum 4 serving as a photosensitive member with a light beam. The light scanning apparatus 400 includes a laser drive portion 300. The laser drive portion 300 is configured to emit a laser light beam (hereinafter referred to as “light beam”) 208 based on a VDO signal 110 serving as an image signal output from an image signal generating portion 100 and a control signal 310 output from a controller 1. The light beam 208 scans the surface of the photosensitive drum 4, which is uniformly charged by a charger 31 serving as a charging unit, to form an electrostatic latent image (hereinafter referred to as “latent image”) on the surface of the photosensitive drum 4. A developing device 32 serving as a developing unit is configured to cause a toner serving as a developer to adhere to the latent image to form a toner image. A recording medium S, for example, a paper sheet, is received in a feeder unit 8. The recording medium S fed from the feeder unit 8 by a pickup roller 33 is conveyed to a transfer position by feed rollers 5 so as to be brought into contact with the photosensitive drum 4. The toner image is transferred onto the recording medium S conveyed to the transfer position by a transfer roller 34. The toner image transferred onto the recording medium S is heated and pressurized by a fixing device 6 to be fixed to the recording medium S. The recording medium S having an image formed thereon is delivered to a delivery tray 35 by delivery rollers 7.

<Light Scanning Apparatus>

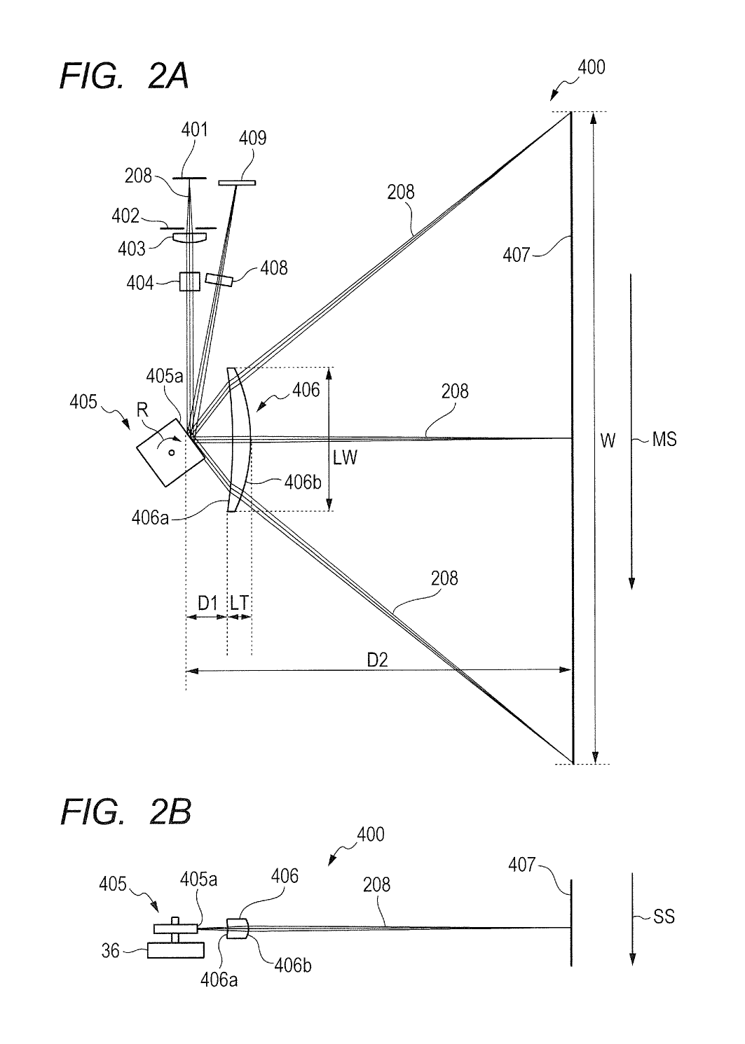

FIG. 2A and FIG. 2B are sectional views of the light scanning apparatus 400. FIG. 2A is a diagram for illustrating a main scanning section of the light scanning apparatus 400. FIG. 2B is a diagram for illustrating a sub-scanning section of the light scanning apparatus 400. The main scanning section is a cross section obtained by taking the light scanning apparatus 400 along a plane containing an optical axis of an imaging lens (imaging optical element) 406 and a main scanning direction MS. The sub-scanning section is a cross section obtained by taking the light scanning apparatus 400 along a plane containing the optical axis of the imaging lens 406 and being perpendicular to the main scanning section. The light scanning apparatus 400 includes a light source 401, a rotary polygon mirror 405 serving as a deflection device, and a casing (optical housing) 400a illustrated in FIG. 1. The light source 401 is configured to emit the light beam 208. The rotary polygon mirror 405 is configured to deflect the light beam 208 so that the light beam 208 emitted from the light source 401 scans the surface of the photosensitive drum 4 (hereinafter referred to as “scanned surface 407”). The casing 400a is mounted with the light source 401, and holds the rotary polygon mirror 405 and optical elements in the inside. In a first embodiment of the present invention, the light beam 208 emitted from the light source 401 is shaped to have an elliptic shape by the aperture diaphragm 402 to enter the coupling lens 403. The light beam 208 that has passed through the coupling lens 403 is converted into substantially collimated light to enter an anamorphic lens 404. The substantially collimated light includes weak convergent light and weak divergent light. The anamorphic lens 404 has a positive refractive power within the main scanning section, and is configured to convert the incoming light beam into the light beam 208 converged within the main scanning section. The anamorphic lens 404 is also configured to condense the light beam 208 in the vicinity of a reflection surface 405a, which serves as a deflecting surface of the rotary polygon mirror 405, within the sub-scanning section to form a line image that is long in the main scanning direction MS.

The light beam 208 that has passed through the anamorphic lens 404 is deflected by a plurality of reflection surfaces 405a of the rotary polygon mirror 405. The light beam 208 that has been deflected by the reflection surface 405a is transmitted through the imaging lens 406 to be imaged on the scanned surface 407 as a light spot. The imaging lens 406 is an imaging optical element. In the first embodiment, an imaging optical system is formed of only a single imaging optical element (imaging lens 406). The light beam 208 is imaged on the scanned surface 407 by the imaging lens 406 to form an image (light spot) having a predetermined spot shape. The rotary polygon mirror 405 is rotated in a direction indicated by an arrow R at a constant angular velocity by a motor 36 serving as a drive device. The light spot is moved on the scanned surface 407 in the main scanning direction MS to form a latent image on the scanned surface 407. The main scanning direction MS is a direction parallel with the surface of the photosensitive drum 4 and perpendicular to a moving direction of the surface (rotation direction) of the photosensitive drum 4. A sub-scanning direction SS is a direction perpendicular to the main scanning direction MS and the optical axis of the light beam 208.

A beam detector (hereinafter referred to as “BD”) 409 and a BD lens 408 form an optical system for generating a synchronization signal for determining a timing to write a latent image on the scanned surface 407. The light beam 208 that has passed through the BD lens 408 enters the BD 409 including a photodiode to be detected thereby. The writing timing of the light beam 208 is controlled based on the timing at which the light beam 208 is detected by the BD 409.

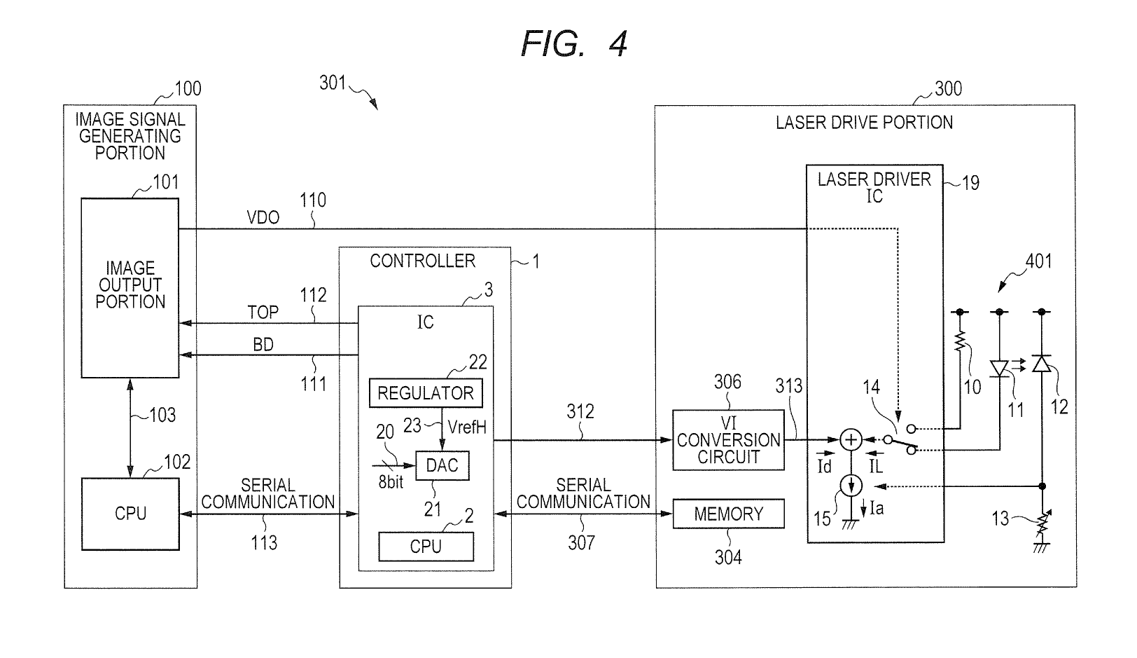

The light source 401 is a semiconductor laser chip. The light source 401 of the first embodiment includes one light emitting portion 11 illustrated in FIG. 4. However, the light source 401 may include a plurality of light emitting portions capable of independently controlling light emission. Also when the plurality of light emitting portions are included, a plurality of light beams emitted from the plurality of light emitting portions each pass through the coupling lens 403, the anamorphic lens 404, the rotary polygon mirror 405, and the imaging lens 406 to reach the scanned surface 407. A plurality of light spots corresponding to the plurality of light beams are formed on the scanned surface 407 at positions displaced in the sub-scanning direction SS. The light source 401, the coupling lens 403, the anamorphic lens 404, the imaging lens 406, the rotary polygon mirror 405, and other such various optical members are held in the casing 400a of the light scanning apparatus 400 illustrated in FIG. 1.

<Imaging Lens>

As illustrated in FIG. 2A and FIG. 2B, the imaging lens 406 has two optical surfaces (lens surfaces) including an incident surface (first surface) 406a and an outgoing surface (second surface) 406b. The imaging lens 406 is configured so that, within the main scanning section, the light beam 208 deflected by the reflection surface 405a is transmitted through the imaging lens 406 to scan the scanned surface 407 with a predetermined scanning characteristic. The imaging lens 406 is also configured to change the light spot of the light beam 208 on the scanned surface 407 so as to have a predetermined shape. The imaging lens 406 is also configured to bring the vicinity of the reflection surface 405a and a vicinity of the scanned surface 407 to an optically conjugate relationship within the sub-scanning section. The imaging lens 406 is thus configured to compensate an optical face tangle error. When the reflection surface 405a of the rotary polygon mirror 405 is inclined with respect to a rotary axis of the rotary polygon mirror 405, a scanning position of the light beam 208 is deviated in the sub-scanning direction SS on the scanned surface 407. The imaging lens 406 can reduce the deviation of the scanning position in the sub-scanning direction SS, which is caused by the optical face tangle error. The imaging lens 406 of the first embodiment is a plastic molded lens formed by injection molding, but a glass molded lens may be employed as the imaging lens 406. A molded lens is easy to be molded into an aspherical shape, and is suitable for mass production. It is possible to achieve improvements in productivity and optical performance of the imaging lens 406 by employing the molded lens as the imaging lens 406.

The imaging lens 406 does not have an fθ characteristic, or has an fθ characteristic weaker than that of a related-art fθ lens. That is, the imaging lens 406 does not have such a scanning characteristic as to image the light beam, which is passing through the imaging lens 406 while the rotary polygon mirror 405 is being rotated at a constant angular velocity, as the light spot moving on the scanned surface 407 at a constant speed. The imaging lens 406 can be arranged in proximity to the rotary polygon mirror 405 through use of the imaging lens 406 that does not have the fθ characteristic. That is, a distance D1 between the rotary polygon mirror 405 and the imaging lens 406 illustrated in FIG. 2A can be reduced. Further, the imaging lens 406 that does not have the fθ characteristic can have a width LW of the imaging lens 406 in the main scanning direction MS and a thickness LT of the imaging lens 406 in the optical axis direction made smaller than those of an imaging lens having an fθ characteristic. This enables reduction in size of the casing 400a of the light scanning apparatus 400 illustrated in FIG. 1. Further, the imaging lens having the fθ characteristic may have a part exhibiting an abrupt change in shapes of an incident surface and an outgoing surface of the imaging lens in the main scanning section. Such an imaging lens may not exhibit satisfactory imaging performance due to the abrupt change in the shapes of the incident surface and the outgoing surface. In contrast, the imaging lens 406 that does not have the fθ characteristic does not have the part exhibiting the abrupt change in the shapes of the incident surface 406a and the outgoing surface 406b of the imaging lens 406 in the main scanning section, and can therefore exhibit satisfactory imaging performance. The scanning characteristic of the imaging lens 406 that does not have the fθ characteristic is expressed by Expression (1).

$$Y = \frac{K}{B} tan ( B θ ) \qquad Expression ( 1 )$$

In Expression (1), θ represents an angle (hereinafter referred to as “scanning angle”) between the optical axis of the imaging lens 406 and the light beam 208 deflected by the rotary polygon mirror 405. Y (mm) represents a distance (hereinafter referred to as “image height”) between the optical axis of the imaging lens 406 and a position (focused position) of the light spot of the light beam 208 imaged on the scanned surface 407 in the main scanning direction MS. K (mm) represents an imaging coefficient (hereinafter referred to as “on-axis image height”) at an image height on the optical axis of the imaging lens 406. B represents a coefficient (hereinafter referred to as “scanning characteristic coefficient”) for determining the scanning characteristic of the imaging lens 406. The on-axis image height represents the image height on the optical axis of the imaging lens 406, and is therefore an image height Y (Y=0=Ymin) exhibited when the scanning angle θ is 0 (θ=0). In the first embodiment, the image height (Y≠0) at a position (θ≠0) deviated from the optical axis (0=0) of the imaging lens 406 is referred to as “off-axis image height”. In addition, image heights (Y=+Ymax and Y=−Ymax) at positions (θ=+θmax and θ=−θmax) being farthest from the optical axis of the imaging lens 406 (θ=0) are each referred to as “outermost off-axis image height”. A width (hereinafter referred to as “scanning width”) W of a predetermined region (hereinafter referred to as “scanning region”) that allows the latent image to be formed on the scanned surface 407 in a main scanning direction is expressed as W=|+Ymax|+|−Ymax|. The center of the scanning region corresponds to the on-axis image height. Both end portions of the scanning region each correspond to the outermost off-axis image height. A deflection angle of the light beam required for scanning the scanning region by the scanning width W corresponds to a scanning field angle.

In this case, the imaging coefficient K is a coefficient corresponding to “f” in a scanning characteristic (fθ characteristic) Y=fθ exhibited when collimated light enters the imaging lens 406. That is, the imaging coefficient K is a coefficient for bringing the image height Y and the scanning angle θ to a proportional relationship in the same manner as the fθ characteristic when light other than the collimated light enters the imaging lens 406. To give further details of the scanning characteristic coefficient B, Expression (1) becomes Y=Kθ when B=0, which corresponds to the scanning characteristic Y=fθ (equidistant projection method) of an imaging lens used for a related-art light scanning apparatus. Further, Expression (1) becomes Y=K tan θ when B=1, which corresponds to a projection characteristic Y=f tan θ (central projection method) of a lens used for an image pickup apparatus (camera) or the like. That is, it is possible to obtain a scanning characteristic between the projection characteristic Y=f tan θ and the fθ characteristic Y=fθ by setting the scanning characteristic coefficient B within a range of 0≤B≤1 in Expression (1).

In this case, when Expression (1) is differentiated with respect to the scanning angle θ, a scanning speed dY/dθ of the light beam on the scanned surface 407 with respect to the scanning angle θ is obtained as indicated in Expression (2).

$$\frac{dY}{d θ} = \frac{K}{{cos}^{2} ( B θ )} \qquad Expression ( 2 )$$

According to Expression (2), the scanning speed dY/dθ at the on-axis image height (θ=0) becomes K because the scanning angle θ is 0 (θ=0). When Expression (2) is further divided by the scanning speed dY/dθ=K at the on-axis image height, Expression (3) is obtained.

$$\frac{\frac{dY}{d θ}}{K} - 1 = \frac{1}{{cos}^{2} ( B θ )} - 1 = {tan}^{2} ( B θ ) \qquad Expression ( 3 )$$

Expression (3) indicates a deviation amount (partial magnification) of the scanning speed dY/dθ at the off-axis image height with respect to the scanning speed K at the on-axis image height. In the first embodiment, the partial magnification at the image height Y is expressed as a percentage (%) of a deviation amount ((dY/dθ)/K−1) obtained by subtracting 1 from a ratio ((dY/dθ)/K) of the scanning speed dY/dθ at the off-axis image height to the scanning speed K at the on-axis image height. The scanning speed of the light beam 208 emitted from the light scanning apparatus 400 using the imaging lens 406 of the first embodiment differs between at the on-axis image height (Y=0=Ymin) and at the off-axis image height Y (Y≠0) except when the scanning characteristic coefficient B is 0 (B=0).

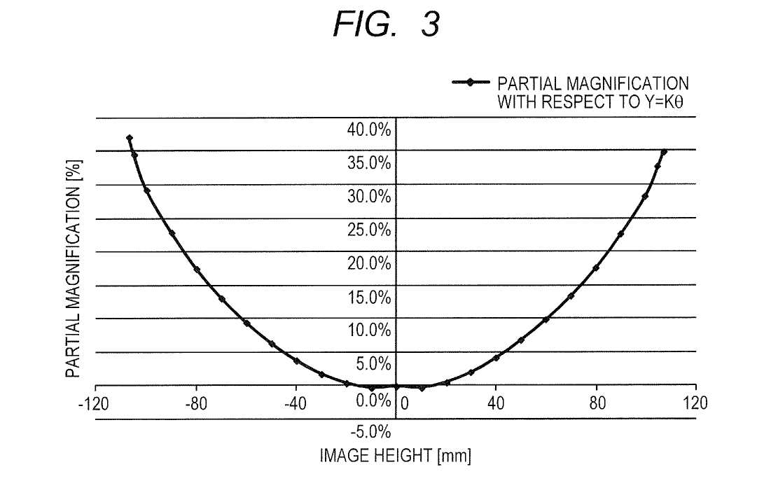

FIG. 3 is a graph for showing the partial magnification (%) with respect to the image height Y (mm) for the light scanning apparatus 400. In FIG. 3, there is shown a relationship between the image height Y and the partial magnification, which is exhibited when the image height Y on the scanned surface 407 is expressed by the scanning characteristic of Y=Kθ. When the imaging lens 406 has the scanning characteristic of Y=Kθ, as shown in FIG. 3, the partial magnification increases as the image height becomes farther from the on-axis image height (Y=0) and closer to the respective outermost off-axis image heights (Y=+Ymax and Y=−Ymax). This is because the scanning speed gradually increases as the image height becomes farther from the on-axis image height and closer to the outermost off-axis image height. For example, the partial magnification of 30% means that, when the light beam is scanned in the main scanning direction for a unit time, a length (hereinafter referred to as “scanning length”) by which the scanned surface 407 is scanned with the light beam in the main scanning direction is 1.3 times longer than a scanning length at the on-axis image height. Thus, when a pixel width in the main scanning direction is determined based on a fixed time interval determined by a cycle period of an image clock, a scanning length per pixel differs between at the on-axis image height (Y=0) and at the off-axis image height (Y≠0). Therefore, the scanning length per pixel in the main scanning direction at the off-axis image height (Y≠0) becomes longer than the scanning length per pixel in the main scanning direction at the on-axis image height (Y=0), and a pixel density changes depending on the image height (position in the main scanning direction). Further, the scanning speed gradually becomes higher as the image height Y becomes farther from the on-axis image height and closer to the outermost off-axis image height (as the absolute value of the image height Y becomes larger). Therefore, a time required for the light spot near the outermost off-axis image height to scan the scanned surface 407 by a unit length is shorter than a time required for the light spot near the on-axis image height to scan the scanned surface 407 by the unit length. This means that, when a light emission luminance of the light source 401 is constant, an exposure amount per unit length with the image height being near the outermost off-axis image height becomes smaller than an exposure amount per unit length with the image height being near the on-axis image height.

In a case of the imaging lens 406 having such a scanning characteristic as described above, variations in partial magnification that depend on a main scanning position and variations in exposure amount per unit length that depend on the main scanning position may exert adverse influence in maintaining satisfactory image quality. In view of this, in the first embodiment, in order to obtain satisfactory image quality, correction of the partial magnification and brightness correction for correcting the exposure amount per unit length are performed. In particular, the scanning field angle becomes larger as an optical path length between the rotary polygon mirror 405 and the photosensitive drum 4 becomes shorter, and hence a difference between the scanning speed at the on-axis image height and the scanning speed at the outermost off-axis image height becomes larger. According to extensive investigation of the inventor, it has been clarified that, when the light scanning apparatus 400 is reduced in size, the scanning speed at the outermost off-axis image height becomes equal to or larger than 120% of the scanning speed at the on-axis image height. In this case, the rate of change in scanning speed of the light scanning apparatus 400 is equal to or larger than 20%. In a case of such a light scanning apparatus 400, it becomes difficult to maintain satisfactory image quality due to the influence of the variations in the partial magnification depending on the main scanning position and the variations in exposure amount per unit length depending on the main scanning position.

A rate C (%) of change in scanning speed has a value expressed as C=((Vmax−Vmin)/Vmin)*100, where Vmin represents the lowest scanning speed and Vmax represents the highest scanning speed. In the light scanning apparatus 400 of the first embodiment, the scanning speed becomes the lowest scanning speed Vmin at the on-axis image height (center of the scanning region), and becomes the highest scanning speed Vmax at the outermost off-axis image height (both end portions of the scanning region). According to the extensive investigation of the inventor, it has been clarified that the rate of change in scanning speed becomes equal to or larger than 35% when the scanning field angle is equal to or larger than 52°. Examples of a condition for the scanning field angle becoming equal to or larger than 52° is as follows.

### Example 1

The scanning width W is 214 mm (W=214 mm) when a latent image having a width equal to a short side of an A4 sheet is formed in the main scanning direction. An optical path length D2 between the reflection surface 405a and the scanned surface 407, which is illustrated in FIG. 2A, is equal to or shorter than 125 mm (D2≤125 mm) when the scanning angle is 0°.

### Example 2

The scanning width W is 300 mm (W=300 mm) when a latent image having a width equal to a short side of an A3 sheet is formed in the main scanning direction. An optical path length D2 between the reflection surface 405a and the scanned surface 407, which is illustrated in FIG. 2A, is equal to or shorter than 247 mm (D2≤247 mm) when the scanning angle is 0°.

An image forming apparatus including the light scanning apparatus 400 satisfying one of the above-mentioned conditions, to which the first embodiment described below is applied, can obtain satisfactory image quality through use of the imaging lens 406 that does not have the fθ characteristic.

<Exposure Control System>

FIG. 4 is a block diagram of an exposure control system 301 of the image forming apparatus 9. The image signal generating portion 100 includes an image output portion 101 and a CPU 102. The image signal generating portion 100 is configured to perform various operations under the control of the CPU 102. The image output portion 101 is connected to the CPU 102 by a system bus 103. The image signal generating portion 100 receives information including a print job from a host computer (not shown), and generates the VDO signal 110 as the image signal based on image data included in the information. The image signal generating portion 100 also has a function of that of a pixel width correction unit. The controller 1 is configured to control the image forming apparatus 9. The controller 1 also has a function of that of a brightness correction unit configured to control a light intensity of the light source 401. The laser drive portion 300 is configured to supply a current to the light source 401 based on the VDO signal 110 to cause the light source 401 to emit a light beam.

The image signal generating portion 100 transmits a signal for instructing to start printing to the controller 1 through a serial communication 113 when the VDO signal 110 for image formation is ready to be output. When printing is ready to be performed, the controller 1 transmits the TOP signal 112, which is a sub-scanning synchronization signal for notifying positional information on a leading edge part of a recording medium, and a BD signal 111, which is a main scanning synchronization signal for notifying positional information on a left edge part of the recording medium, to the image signal generating portion 100. When receiving the TOP signal 112 and the BD signal 111, the image signal generating portion 100 outputs the VDO signal 110 to the laser drive portion 300 at a predetermined timing.

Next, the brightness correction to be performed for improving an image will be described. The controller 1 includes an integrated circuit (hereinafter referred to as “IC”) 3. The IC 3 has built therein a CPU 2, a DA converter (hereinafter referred to as “DAC”) 21 configured to convert an 8-bit digital signal 20 into an analog signal, and a regulator 22. The IC 3 functions as the brightness correction unit together with the laser drive portion 300. The laser drive portion 300 includes a memory 304, a voltage/current conversion circuit (hereinafter referred to as “VI conversion circuit”) 306 configured to convert a voltage into a current, a laser driver IC 19, and the light source 401. The laser drive portion 300 supplies the drive current IL to the light emitting portion 11 being a laser diode of the light source 401. The memory (first storage portion) 304 stores partial magnification characteristic information (profile) including partial magnifications corresponding to a plurality of image heights (a plurality of positions in the main scanning direction) and information on a correction current to be supplied to the light emitting portion 11. It suffices that the partial magnification characteristic information is a profile indicating magnification correction data used for correcting the partial magnification for each of a plurality of regions in the main scanning direction. The partial magnification characteristic information may be information (magnification correction data) including the scanning speed of the light spot on the scanned surface 407 corresponding to the image height (position in the main scanning direction) for each of the plurality of regions.

The information stored in the memory 304 is transmitted to the IC 3 through a serial communication 307 based on the control of the CPU 2. The IC 3 adjusts a voltage (VrefH) 23 output from the regulator 22 based on the information on the correction current to be supplied to the light emitting portion 11 stored in the memory 304. The voltage 23 serves as a reference voltage for the DAC 21. The IC 3 sets the 8-bit digital signal (input data) 20 to be input to the DAC 21, and outputs an analog voltage for brightness correction (hereinafter referred to as “brightness correction analog voltage”) 312 that increases or decreases within a main scanning segment in synchronization with the BD signal 111. The brightness correction analog voltage 312 that increases or decreases within the main scanning segment is input to the VI conversion circuit 306. The VI conversion circuit 306 is configured to convert the brightness correction analog voltage 312 into a current Id 313, and to output the current Id 313 to the laser driver IC 19. In the first embodiment, the IC 3 mounted to the controller 1 outputs the brightness correction analog voltage 312, but the DAC may be provided on the laser drive portion 300 to generate the brightness correction analog voltage 312 near the laser driver IC 19.

The laser driver IC 19 uses a switching circuit 14 to switch between whether to flow the drive current IL to the light emitting portion 11 or to flow the drive current IL to the dummy the resistance 10 based on the VDO signal 110. The switching circuit 14 is configured to control the ON/OFF of the light emission from the light source 401 based on a VDO signal. The drive current IL (third current) supplied to the light emitting portion 11 is a current obtained by subtracting a current Id (second current) output by the VI conversion circuit 306 from a current Ia (first current) set by a constant current circuit 15. A photodiode (photoelectric conversion element) 12 is provided to the light source 401, and is configured to detect the brightness (light intensity) of the light emitting portion 11. The current Ia flowing through the constant current circuit 15 is automatically adjusted by feedback control of an internal circuit of the laser driver IC 19 so that the brightness detected by the photodiode 12 becomes a predetermined brightness. The automatic adjustment of the light intensity of the light emitting portion 11 is so-called auto power control (APC) for automatic light intensity control. The brightness adjustment of the light emitting portion 11 using the automatic adjustment of the current Ia is carried out while light is being emitted from the light emitting portion 11 in order to detect a BD signal outside a printing region for each main scanning. A variable resistor 13 has a value adjusted at a time of factory assembly so that a predetermined voltage is input from the photodiode 12 to the laser driver IC 19 when light is being emitted from the light emitting portion 11 with a predetermined brightness.

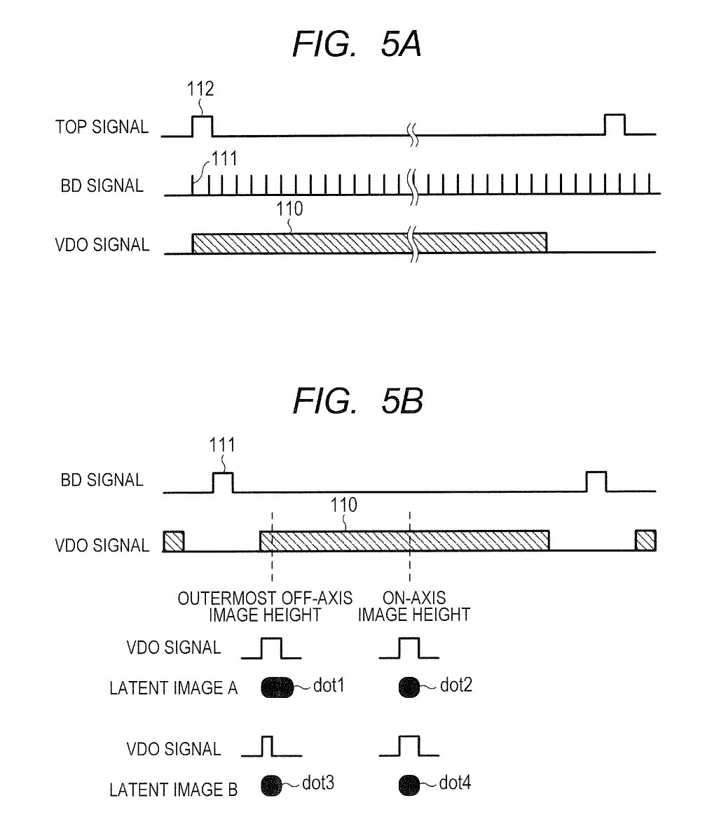

FIG. 5A and FIG. 5B are timing charts of a BD signal (synchronization signal) and a VDO signal (image signal). FIG. 5A is the timing chart of a TOP signal, a BD signal, and a VDO signal for an image forming operation corresponding to one page of a recording medium. In FIG. 5A, time elapses from the left to the right. “HIGH” of the TOP signal 112 indicates that the leading edge part of the recording medium has reached a predetermined position. When receiving “HIGH” of the TOP signal 112, the image signal generating portion 100 outputs the VDO signal 110 in synchronization with the BD signal 111. The light source 401 emits light and forms a latent image on the surface of the photosensitive drum 4 based on the VDO signal 110. In FIG. 5A, in order to simplify the illustration, the VDO signal 110 is drawn as being continuously output across a plurality of BD signals 111. However, in an actual case, the VDO signal 110 is output for a predetermined period since after the BD signal 111 is output until before the next BD signal 111 is output as illustrated in FIG. 5B.

<<Partial Magnification Correction>>

Next, a method of correcting the partial magnification will be described. Prior to the description of the partial magnification correction, a factor of the partial magnification and a correction principle therefor will be described with reference to FIG. 5B. FIG. 5B is the timing chart of the BD signal 111 and the VDO signal 110, and is an explanatory diagram for illustrating the latent image formed on the scanned surface 407. In FIG. 5B, time elapses from the left to the right. When receiving a rising edge of the BD signal 111, the image signal generating portion 100 outputs the VDO signal 110 after a predetermined time period so as to enable formation of the latent image to be started from a writing start position spaced apart from the left edge of the photosensitive drum by a predetermined distance. The laser driver IC 19 controls the ON/OFF of the light emission from the light source 401 based on the VDO signal 110 to form the latent image on the scanned surface 407 based on the VDO signal 110.

Latent images A (latent image dot1 and latent image dot2) each having a dot shape, which are illustrated in FIG. 5B, are formed by emitting light from the light source 401 for the same period at the outermost off-axis image height and at the on-axis image height based on the VDO signal 110. The latent image dot1 and the latent image dot2 are each formed based on the VDO signal 110 corresponding to 1 dot (width of 42.3 μm in the main scanning direction) within 600 dpi. As described above, the light scanning apparatus 400 includes such an optical configuration that the scanning speed at the edge part (outermost off-axis image height) on the scanned surface 407 is higher than the scanning speed at the center (on-axis image height) on the scanned surface 407. When the partial magnification correction is not executed, as is clear from the latent images A (latent image dot1 and latent image dot2) illustrated in FIG. 5B, the latent image dot1 at the outermost off-axis image height is enlarged in the main scanning direction to a higher level than the latent image dot2 at the on-axis image height. In view of this, a cycle period and a time width of the VDO signal 110 is corrected based on the position in the main scanning direction, to thereby execute the partial magnification correction. Specifically, a light emission time interval at the outermost off-axis image height is made shorter than a light emission time interval at the on-axis image height to reduce the length of the latent image dot1 at the outermost off-axis image height in the main scanning direction, to thereby execute the partial magnification correction. When the partial magnification correction is executed, as in latent images B (latent image dot3 and latent image dot4) illustrated in FIG. 5B, the length of the latent image dot3 at the outermost off-axis image height in the main scanning direction becomes the same as the length of the latent image dot4 at the on-axis image height in the main scanning direction. In regard to the main scanning direction, the partial magnification correction enables a substantial cycle period of each pixel to be reduced at the both end portions of the main scanning segment and a substantial cycle period of the pixel to be increased at the center of the main scanning segment. With this configuration, it is possible to form a normal image even with the image forming apparatus 9 using the imaging lens 406 that does not have the fθ characteristic.

(Image Signal Generating Portion)

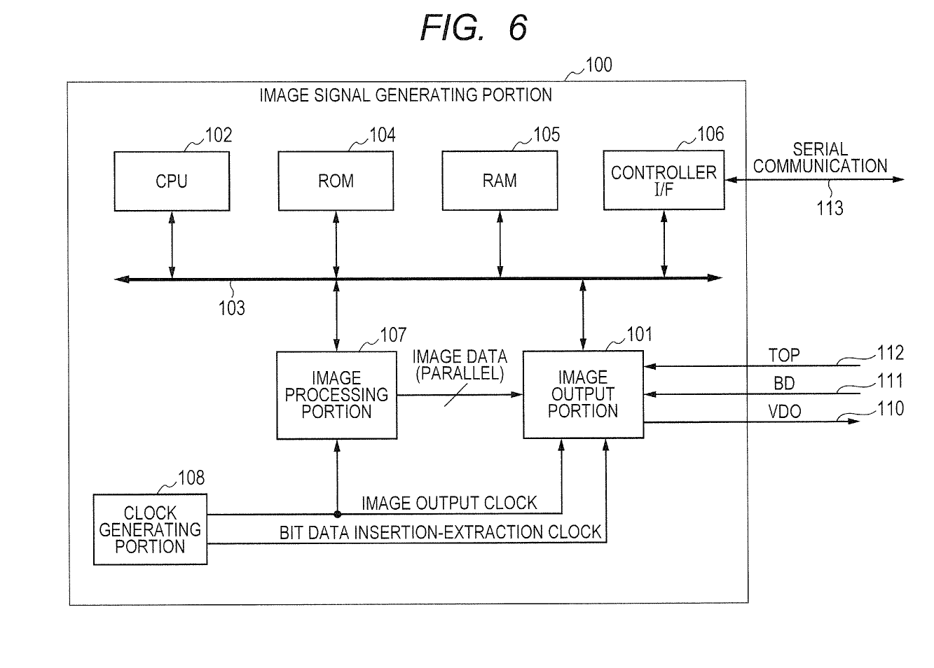

Next, a method of controlling the image signal generating portion 100 of the first embodiment will be described. FIG. 6 is a block diagram of the image signal generating portion 100. The image signal generating portion 100 generates the VDO signal 110 as bit data obtained by splitting the image data by a predetermined integer value (32 in the first embodiment) for each pixel. The image signal generating portion 100 includes the image output portion 101, the CPU 102, a ROM 104, a RAM 105, a controller interface (hereinafter referred to as “I/F”) 106, an image processing portion 107, and the clock generating portion 108. The system bus 103 is configured to connect the image output portion 101, the CPU 102, the ROM 104, the RAM 105, the controller I/F 106, and the image processing portion 107 to one another. The CPU 102 is configured to control the image signal generating portion 100. The ROM 104 is configured to store a control program. The RAM 105 is configured to have the control program of the ROM 104 loaded thereon, and to operate as a work memory for the CPU 102. The controller I/F 106 performs the serial communication 113 to/from the controller 1. The clock generating portion 108 includes a phase lock loop (PLL), and is configured to output an image output clock and a bit data insertion-extraction clock. In this case, the bit data insertion-extraction clock is an integral multiple of the image output clock. One pixel is split by a predetermined integer value. One pixel is formed of pieces of bit data the number of which is equal to the predetermined integer value. The bit data insertion-extraction clock has a frequency of a multiple of the predetermined integer value of the image output clock. For example, in the first embodiment, one pixel is split into 32 pieces of bit data, and hence the bit data insertion-extraction clock has 32 times as large a frequency as the image output clock. The predetermined integer value is not limited to 32, and any integer values including 8, 16, and 64 may be employed.

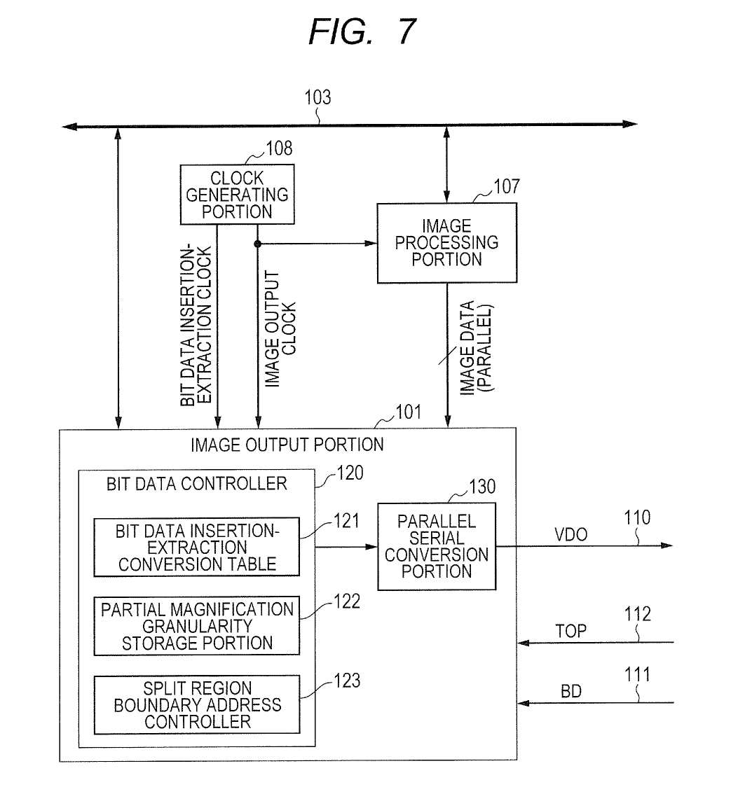

FIG. 7 is a block diagram of the image output portion 101. The image output portion 101 includes a bit data controller 120 and a parallel-serial conversion portion 130. The bit data controller 120 is configured to control the insertion-extraction of the bit data. The bit data controller 120 includes a bit data insertion-extraction conversion table 121, a partial magnification granularity storage portion 122, and a split region boundary address controller 123. The bit data insertion-extraction conversion table 121 is used for converting a bit data insertion-extraction pattern. The partial magnification granularity storage portion (second storage portion) 122 is configured to store a partial magnification granularity. The partial magnification granularity represents a size of a processing unit used for splitting a partial magnification correction start value (maximum value of the partial magnification). The split region boundary address controller 123 is configured to control a split region boundary address in the main scanning direction. The parallel-serial conversion portion 130 is configured to convert the image data (parallel data) received from the image processing portion 107 into the VDO signal 110 being serial data.

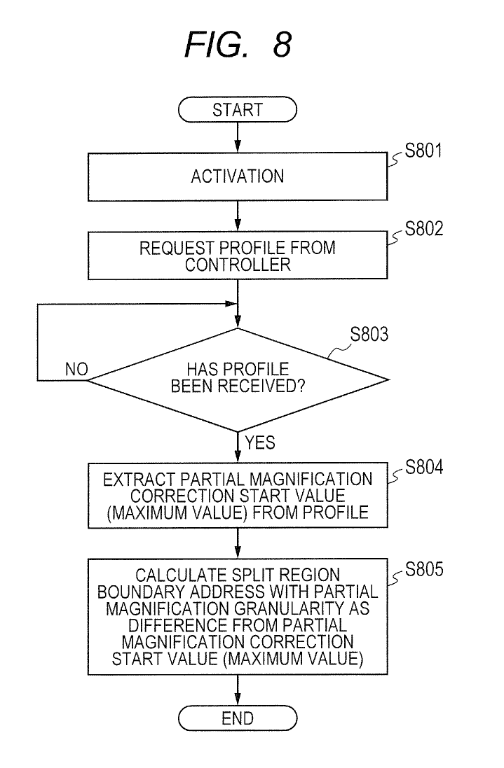

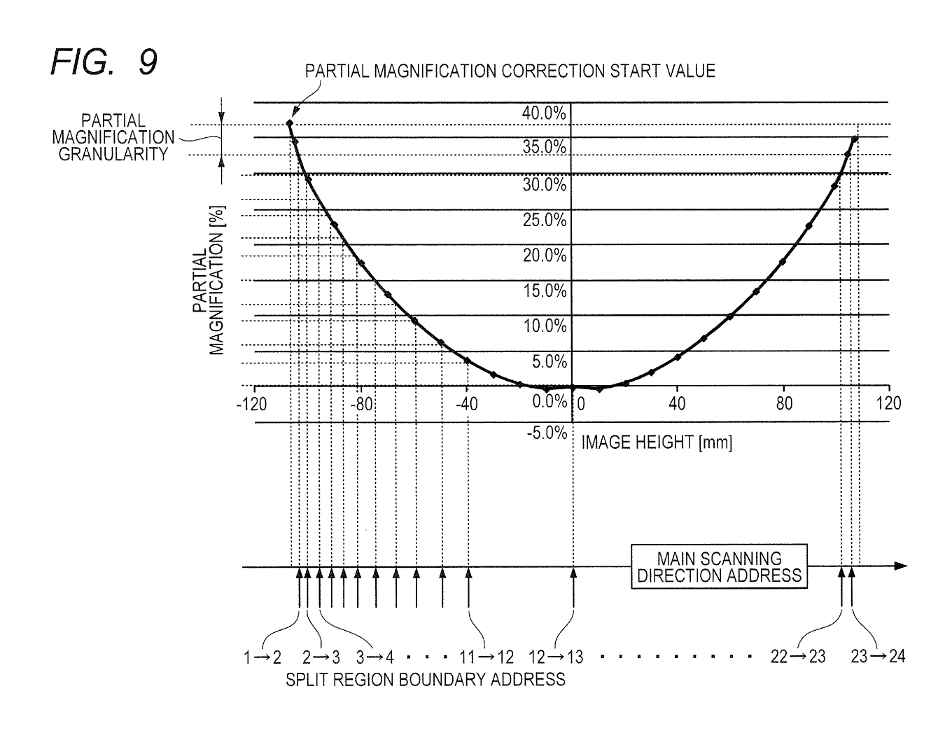

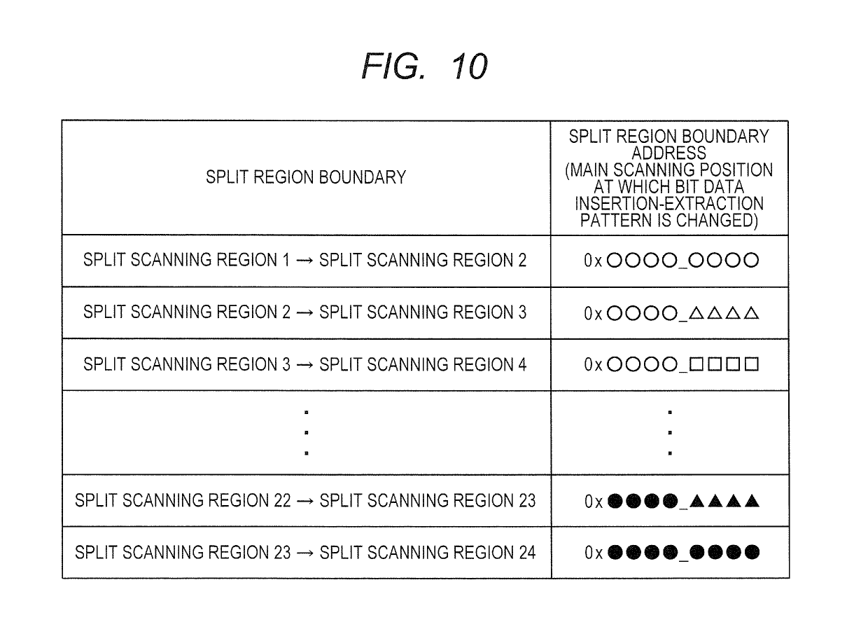

Next, a calculation operation for the split region boundary address will be described with reference to FIG. 8, FIG. 9, and FIG. 10. In the first embodiment, operation procedures for setting and control are executed by the CPU 102 based on the control program stored in the ROM 104 of the image signal generating portion 100 or loaded onto the RAM 105 of the image signal generating portion 100. FIG. 8 is a flowchart for illustrating the calculation operation for the split region boundary address. When the image forming apparatus 9 is activated (Step S801), the image signal generating portion 100 requests a profile from the controller 1 (Step S802). In this case, the profile represents information on the partial magnification with respect to the image height, which is shown in FIG. 3. The profile indicates the magnification correction data for each of the plurality of regions in the main scanning direction. When the image signal generating portion 100 receives the profile (YES in Step S803), the image signal generating portion 100 extracts the partial magnification correction start value, that is, the maximum value of the partial magnification, from the profile (Step S804). Subsequently, the image signal generating portion 100 calculates the split region boundary address for each partial magnification granularity at the main scanning position based on the partial magnification granularity stored in the partial magnification granularity storage portion 122 and the partial magnification correction start value (Step S805). The split region boundary address indicates a position (main scanning position) at which the scanning region on the surface of the photosensitive member to be scanned with the light beam is split in the main scanning direction for each partial magnification granularity.

The calculation of the split region boundary address will be described with reference to FIG. 9. FIG. 9 is an explanatory graph for showing the split region boundary address. The split region boundary address is an address indicating the position of a boundary between split scanning regions obtained by splitting the scanning region by the partial magnification granularity in the main scanning direction. The bit data insertion-extraction pattern is set for each of the split scanning regions obtained by splitting the scanning region by the partial magnification granularity. That is, the split region boundary address indicates the position (hereinafter referred to as “main scanning position”) in the main scanning direction at which the bit data insertion-extraction pattern is to be changed. In the first embodiment shown in FIG. 9, the partial magnification correction start value (maximum value of the partial magnification) is 36%, and the partial magnification granularity is 3%. The partial magnification granularity is calculated as 3% based on the above-mentioned setting that the bit data insertion-extraction clock has 32 times as large a frequency as the image output clock. That is, 3% is a ratio obtained by splitting one pixel by 32 ( 1/32 is equal to about 3%). In the first embodiment, one pixel is formed of 32 pieces of bit data, and hence the length of the scanning region is changed by about 3% by inserting/extracting one piece of bit data into/from one pixel. The main scanning position (split region boundary address) of a boundary (split region boundary) between the first split scanning region 1 and the next split scanning region 2 becomes a position exhibiting a partial magnification of 33% that has changed from 36% by 3% based on the partial magnification correction start value of 36% and the partial magnification granularity of 3%. The main scanning position (split region boundary address) of a boundary between the split scanning region 2 and the next split scanning region 3 becomes a position exhibiting a partial magnification of 30% that has changed from 33% by 3%. Through the repetition of the above-mentioned operation, the split region boundary addresses are calculated. After the center (image height of 0 mm) in the main scanning direction is exceeded, the split region boundary address is calculated each time the partial magnification changes by +3%.

FIG. 10 is a table for showing the calculated split region boundary addresses. The split region boundary between the split scanning region 1 and the split scanning region 2 is the main scanning position exhibiting the partial magnification of 33%. The split region boundary address at which a split scanning region is changed from the split scanning region 1 to the split scanning region 2 is an address of image data corresponding to the main scanning position exhibiting the partial magnification of 33%. In the same manner, the split region boundary between the split scanning region 2 and the split scanning region 3 is the main scanning position exhibiting the partial magnification of 30%. The split region boundary address at which the split scanning region is changed from the split scanning region 2 to the split scanning region 3 is an address of image data corresponding to the main scanning position exhibiting the partial magnification of 30%. In this manner, the split region boundary address corresponding to the split region boundary is calculated. In the first embodiment, the scanning region is split into (36÷3×2=24) split scanning regions based on the partial magnification correction start value of 36% and the partial magnification granularity of 3%. In a related-art technology, it is necessary to provide about 8,000 split scanning regions corresponding to the number of pixels in the main scanning direction with 600 dpi in an A3 size. In contrast, according to the first embodiment, only 24 split scanning regions suffices, and hence a circuit scale required for the split scanning regions is reduced.

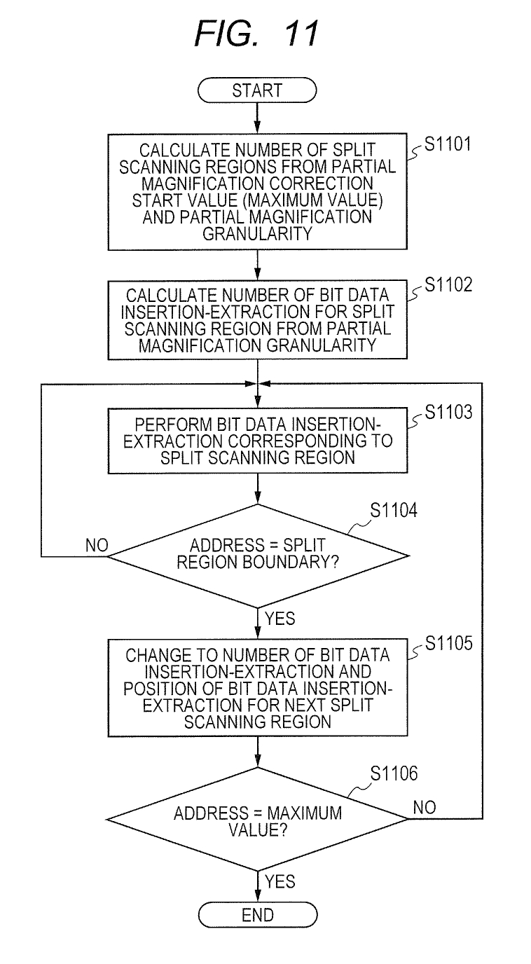

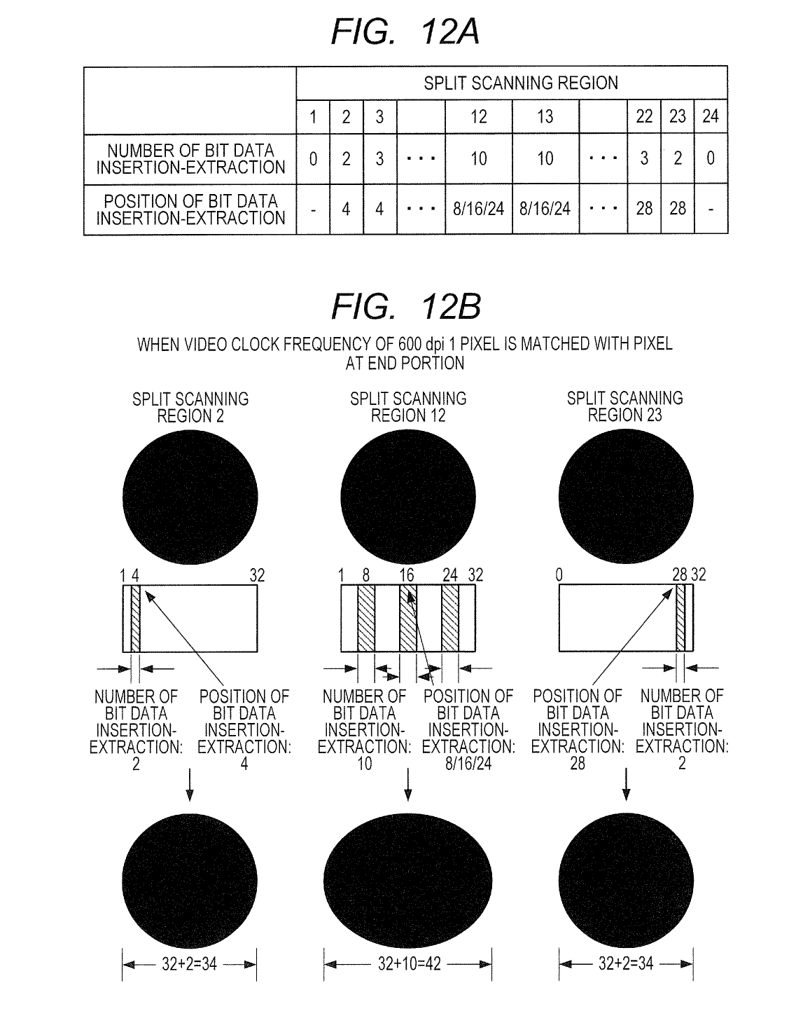

Next, an operation for bit data insertion-extraction will be described with reference to FIG. 11, FIG. 12A, and FIG. 12B. FIG. 11 is a flowchart for illustrating the operation for the bit data insertion-extraction corresponding to the split scanning region. In the first embodiment, the operation procedures for setting and control are executed by the CPU 102 of the image signal generating portion 100 based on the control program stored in the ROM 104 of the image signal generating portion 100 or loaded onto the RAM 105 of the image signal generating portion 100. As described above, the number of split scanning regions is calculated from the partial magnification correction start value (maximum value of the partial magnification) and the partial magnification granularity (Step S1101). In the first embodiment, the partial magnification correction start value is 36% with the partial magnification granularity being 3%, and hence the scanning region is split into 24 (36÷3×2=24). Thus, the number of split scanning regions is 24. Subsequently, the number of pieces of bit data (hereinafter referred to as “number of bit data insertion-extraction”) to be inserted (added) or extracted (deleted) into/from the bit data of one pixel based on the split scanning region is calculated based on the partial magnification granularity (Step S1102).

Now, the operation for the bit data insertion-extraction for inserting/extracting bit data into/from each pixel based on the split scanning region will be described with reference to FIG. 12A and FIG. 12B. The operation for the bit data insertion-extraction is controlled by the bit data controller 120. FIG. 12A and FIG. 12B are an explanatory table and an explanatory diagram of the operation for the bit data insertion-extraction. The bit data insertion-extraction pattern is set for each of 24 split scanning regions. The bit data insertion-extraction pattern includes the number of bit data insertion-extraction (partial magnification correction data) and a position of bit data insertion-extraction (positional information on the bit data) that are set based on 32 pieces of bit data of one pixel. The bit data insertion-extraction pattern is generated through use of the bit data insertion-extraction conversion table 121. FIG. 12A is a table for showing the number of bit data insertion-extraction and the position of bit data insertion-extraction for the split scanning region. The number of bit data insertion-extraction and the position of bit data insertion-extraction are set for each split scanning region. In an example shown in FIG. 12A, for the split scanning region 2, the number of bit data insertion-extraction is 2, and the position of bit data insertion-extraction is 4. As the position of bit data insertion-extraction, numbers are assigned to 32 pieces of bit data of one pixel in order from the left. For a split scanning region 12, the number of bit data insertion-extraction is 10, and the position of bit data insertion-extraction is 8/16/24. For a split scanning region 23, the number of bit data insertion-extraction is 2, and the position of bit data insertion-extraction is 28.

FIG. 12B is a diagram for illustrating each dot before and after bit data insertion. In this example, bit data is inserted into each of pixels at the on-axis image height and the off-axis image height so that the scanning length per pixel becomes substantially the same with a scanning length of a dot of a pixel at the edge part (outermost off-axis image height) of the scanning region being set as a reference. As illustrated in FIG. 12B, for each pixel within the split scanning region 2, 2 pieces of bit data are inserted into the position of the 4th piece of bit data from the left. For each pixel within the split scanning region 12, 3 pieces of bit data are inserted into the position of the 8th piece of bit data from the left, 4 pieces of bit data are inserted into the position of the 16th piece of bit data from the left, and 3 pieces of bit data are inserted into the position of the 24th piece of bit data from the left. For each pixel within the split scanning region 23, 2 pieces of bit data are inserted into the position of the 28th piece of bit data from the left. The bit data insertion-extraction pattern is set in the bit data insertion-extraction conversion table 121.

In the first embodiment, the scanning length of the dot of the pixel at the edge part (outermost off-axis image height) of the scanning region is set as the reference, and hence the number of pieces of bit data to be inserted and the position into which the bit data is to be inserted are set for each split scanning region in the table shown in FIG. 12A. However, when a scanning length of a dot of a pixel at the center (on-axis image height) of the scanning region is set as the reference, the number of pieces of bit data to be extracted and the position from which the bit data is to be extracted may be set for each split scanning region in the bit data insertion-extraction conversion table 121. Further, a scanning length of a dot of a pixel at a predetermined position (off-axis image height) between the edge part (outermost off-axis image height) and the center (on-axis image height) of the scanning region may be set as the reference. In that case, the number of pieces of bit data to be inserted or extracted and the position into/from which the bit data is to be inserted or extracted may be set for each split scanning region in the bit data insertion-extraction conversion table 121. The table shown in FIG. 12A may be set in the bit data insertion-extraction conversion table 121 in advance.

In a related-art technology that does not involve the bit data insertion-extraction pattern set for each split scanning region, it is necessary to provide 32 bits per pixel in order to insert/extract bit data into/from one pixel formed of 32 pieces of bit data. In contrast, according to the first embodiment, the number of bit data insertion-extraction and the position of bit data insertion-extraction are determined in advance based on the partial magnification granularity, which requires only 5 bits in total including 3 bits of the number of bit data insertion-extraction up to 10 and 2 bits of the position of bit data insertion-extraction up to 3 positions. With this configuration, the circuit scale required for the number of bit data insertion-extraction and the position of bit data insertion-extraction is reduced.

The description returns to the flowchart of FIG. 11. The bit data insertion-extraction corresponding to the split scanning region is executed based on the number of bit data insertion-extraction and the position of bit data insertion-extraction that are set in the bit data insertion-extraction conversion table 121 (Step S1103). Specifically, the bit data is inserted/extracted into/from the image data when the image data (parallel data) input from the image processing portion 107 is converted into the VDO signal (serial data) 110 by the parallel-serial conversion portion 130. The bit data is inserted/extracted into/from the pixel data corresponding to the address of the image data in the main scanning direction based on the number of bit data insertion-extraction and the position of bit data insertion-extraction corresponding to the split scanning region. When the address in the main scanning direction is the split region boundary address (YES in Step S1104), the number of bit data insertion-extraction and the position of bit data insertion-extraction corresponding to the current split scanning region are changed to the number of bit data insertion-extraction and the position of bit data insertion-extraction corresponding to the next split scanning region (Step S1105). When the address in the main scanning direction is not the split region boundary address (NO in Step S1104), the bit data insertion-extraction is executed on the pixel data corresponding to the next address of the image data in the main scanning direction (Step S1103). When the address in the main scanning direction is the maximum value, that is, the last address (YES in Step S1106), the processing is brought to an end. When the address in the main scanning direction is not the maximum value (NO in Step S1106), the bit data insertion-extraction is executed on the pixel data corresponding to the address in the main scanning direction based on the number of bit data insertion-extraction and the position of bit data insertion-extraction corresponding to the split scanning region (Step S1103).

According to the first embodiment, it is possible to suppress the circuit scale by calculating the split region boundary address based on the profile indicating the magnification correction data, the partial magnification correction start value, and the partial magnification granularity. It is possible to form an appropriate image by causing the scanning lengths of the respective pixels in the main scanning direction to become substantially the same based on the calculated split region boundary address and the bit data insertion-extraction pattern for the split scanning region.

### Second Embodiment

Next, a second embodiment of the present invention will be described. In the second embodiment, the same components as those of the first embodiment are denoted by like reference symbols, and descriptions thereof are omitted. The image forming apparatus 9, the light scanning apparatus 400, the imaging lens 406, the exposure control system 301, and the image signal generating portion 100 of the second embodiment are the same as those of the first embodiment, and hence descriptions thereof are omitted. In the first embodiment, the image forming apparatus 9 has one intrinsic profile. In this case, the profile represents such information on the partial magnification with respect to the image height as shown in FIG. 3. In the second embodiment, the image forming apparatus 9 has a plurality of intrinsic profiles. For example, a plurality of profiles are provided in association with the plurality of reflection surfaces 405a of the rotary polygon mirror 405. The second embodiment is different from the first embodiment in that the split region boundary address is calculated for each of the plurality of profiles. Different points from the first embodiment will be mainly described below.

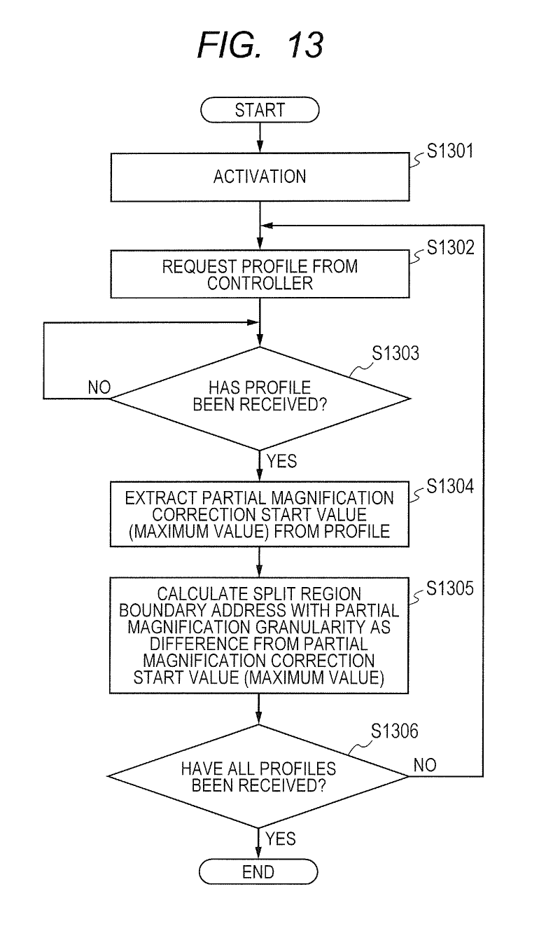

A calculation operation for the split region boundary address performed in the second embodiment will be described with reference to FIG. 13. FIG. 13 is a flowchart for illustrating the calculation operation for the split region boundary address performed in the second embodiment. When the image forming apparatus is activated (Step S1301), the image signal generating portion 100 requests a plurality of profiles from the controller 1 one by one (Step S1302). When the image signal generating portion 100 receives one profile (YES in Step S1303), the image signal generating portion 100 extracts the partial magnification correction start value, that is, the maximum value of the partial magnification, from the received profile (Step S1304). Subsequently, the image signal generating portion 100 calculates the split region boundary address for each partial magnification granularity at the main scanning position based on the partial magnification granularity stored in the partial magnification granularity storage portion 122 and the partial magnification correction start value (Step S1305). Subsequently, the image signal generating portion 100 examines whether or not all the plurality of profiles have been received (Step S1306). When all the profiles have not been received (NO in Step S1306), the image signal generating portion 100 requests the next profile from the controller 1 (Step S1302). After that, in the same manner, the next profile is received, and the split region boundary address is calculated. When all the profiles have been received (YES in Step S1306), the processing is brought to an end.

As described above, even when a plurality of profiles are provided, it is possible to suppress the circuit scale by calculating the split region boundary address based on the partial magnification correction start value and the partial magnification granularity for each of the profiles.

According to the present invention, it is possible to suppress the circuit scale by calculating the split region boundary address based on the profile indicating magnification correction data, the partial magnification correction start value, and the partial magnification granularity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-231084, filed Nov. 29, 2016, which is hereby incorporated by reference herein in its entirety.

What is claimed is:

1. An image forming apparatus, which is configured to form an image on a recording medium, comprising:
an image signal generating portion configured to generate an image signal as bit data obtained by splitting image data by a predetermined integer value for each pixel;
a light source configured to emit a light beam based on the image signal;
a deflection device configured to deflect the light beam emitted from the light source so that the light beam scans a surface of a photosensitive member in a main scanning direction;
a lens configured to image the light beam deflected by the deflection device on the surface of the photosensitive member;
a first storage portion configured to store a profile indicating magnification correction data for each of a plurality of regions in the main scanning direction; and
a second storage portion configured to store a partial magnification granularity being a size of a processing unit used for splitting a partial magnification correction start value,
wherein the image signal generating portion is configured to extract the partial magnification correction start value from the profile, and to calculate a split region boundary address indicating a main scanning position at which a scanning region on the surface of the photosensitive member to be scanned by the light beam is split in the main scanning direction for each partial magnification granularity based on the partial magnification correction start value and the partial magnification granularity.

2. An image forming apparatus according to claim 1, wherein the profile includes a plurality of profiles.

3. An image forming apparatus according to claim 1, wherein the image signal generating portion is configured to calculate a number by which the scanning region is to be split into a plurality of split scanning regions based on the partial magnification correction start value and the partial magnification granularity.

4. An image forming apparatus according to claim 3, wherein the image signal generating portion is configured to calculate, for each of the plurality of split scanning regions, a number of bit data to be added or deleted and a position to which the bit data is to be added or from which the bit data is to be deleted.

5. An image forming apparatus according to claim 4, wherein the image signal generating portion is configured to change the number of bit data to be added or deleted and the position to which the bit data is to be added or from which the bit data is to be deleted each time an address of the image data in the main scanning direction becomes the split region boundary address.

6. An image forming apparatus according to claim 1, wherein the partial magnification correction start value includes a maximum value of a partial magnification of the profile.

7. An image forming apparatus according to claim 6, wherein the partial magnification granularity is obtained based on the predetermined integer value and the maximum value.
